(19) United States
(12) Patent Application Publication
(10) Pub. No.: US 2019/0058954 A1
(43) Pub. Date: Feb. 21, 2019

(54) LAYERED SPEAKER ASSEMBLY

(71) Applicant: Kimon Bellas, Camarillo, CA (US)

(72) Inventors: Kimon Bellas, Camarillo, CA (US); Alan Dwight Hulsebus, II, Simi Valley, CA (US)

(73) Assignee: Kimon Bellas, Camarillo, CA (US)

(21) Appl. No.: 15/682,217

(22) Filed: Aug. 21, 2017

(51) Int. Cl. H04R 9/06; H04R 1/02; H04R 1/20

(52) U.S. Cl. CPC H04R 9/06; H04R 2201/029; H04R 1/20; H04R 1/025

(57) ABSTRACT

Devices and methods described herein relate to novel and improved speaker assembly designs that optimize audio quality. Embodiments herein can also facilitate the tuning of audio range by linearizing frequency and amplitude. Some speaker assembly embodiments herein can improve the audio output by alternating layers of rigid and porous material, which can facilitate aperiodic resonance damping. Embodiments herein can also provide a constant audio output and improve the audio directional pattern. Moreover, speaker assemblies herein can improve the overall audio output at all frequencies by eliminating internal acoustic cavity resonance. Embodiments herein can also customize the audio output through tunable or adjustable components, such as modifying the flow resistance, density, thickness, or shape of cabinet layers. This can also shape the directional frequency response and adjust the damping or resonance frequency. Additionally, this adjustability allows assembly designs to be tailored to all different types of speakers.

### BACKGROUND

### Field

The present disclosure relates generally to audio devices and speakers, and more particularly to speaker assemblies and cabinets with novel and improved layered features and designs.

### Description of the Related Art

Speakers or loudspeakers are typically housed in a cabinet or enclosure. These speaker cabinets or enclosures are often a rectangular or square box made of a variety of materials, such as wood, plastic, or any other appropriate material. The speaker cabinet's design, shape, and materials all influence the quality or type of sound produced. Speakers typically emit sound though the use of transducers or speaker drivers, which are a type of audio transducer that converts electrical audio signals to sound waves. Speaker drivers are commonly associated with specialized transducers, which can reproduce a portion of the audible frequency range. In some instances, multiple speaker drivers or transducers can be mounted in the same cabinet or enclosure, each reproducing a specific part of the audible frequency range.

A conventional speaker system commonly has the back side enclosed by a cabinet so that sound on the back side is contained, such that it will not cancel out sound on the front side. The enclosed cabinet space is an air spring that affects the resonance frequency and damping “Qt” of the speaker. In addition, the enclosed cabinet has acoustic cavity resonances with long decay times at multiple frequencies that degrade the sound quality. This is often described as a “boxy sound.” Some cabinets add a Helmholtz resonator in the form of a tube, slot, or drone cone to form a second and lower resonance frequency at the expense of reduced damping and further extended sound decay time. Speech and music have a “silence” between the different words and notes that is covered up by this resonance with a long decay time.

Dampening materials are often added inside the cabinet to reduce or dampen the resonance. However, dampening materials do not have linear energy absorption with frequency. Accordingly, it is relativity easy to absorb 12 dB energy above 1000 Hz, but it is difficult to absorb 3 dB energy below 100 Hz. This yields a system that has less than optimum resonance dampening character in the bass and midrange leading to the aforementioned “boxy sound.” This problem is typically diagnosed with a “waterfall decay” time frequency response graph to locate the frequency and decay time of the resonance.

Some conventional acoustic solutions to minimize the cabinet resonance are to build a labyrinth, transmission line, infinite baffle, or dipole system. While these solutions are successful in fixing the resonance, they are also large, heavy, and expensive. Dipoles also have a low acoustic efficiency at lower frequencies due to the dipole cancelation.

Inside a room, the ideal speaker would direct all energy towards the listener's ears and minimize off-axis energy that can reflect off the side walls, floor, ceiling, and back wall. One analogy to this situation would be a laser beam versus a lantern. The benefit is, a listener would only hear the room that was recorded—not the room that they were inside—so listeners would feel like they were in the “same room” with the artist. It has often been stated that the largest distortion in a sound reproduction system is the acoustics of the room where the listener was located, caused by reflections, echo, and resonance. Room acoustic problems are typically diagnosed with acoustic measurements of RT60 and “articulation of consonants.” This is the same type of test as the waterfall decay, but on a different time scale.

One way to control directional energy is to use a horn or waveguide. However, the directional control of a horn is limited by the physical dimensions relative to the wavelength of the frequency (e.g. 1 foot =1128 Hz, 10 foot=112 Hz). A horn or waveguide works well for high frequencies, but it becomes too large for low frequencies. This is why professional speakers use a horn tweeter and a conventional box woofer. In this arrangement, the horn is directional and the woofer is omnidirectional at low frequencies. Some coaxial and coincident speakers use the woofer cone as a waveguide for the tweeter. However, none of the aforementioned solutions are cost effective and efficiently designed.

In large venues like cinemas, stadiums, concert halls and houses of worship, multiple woofers are stacked in large arrays until their physical dimension matches the wavelength of the desired directivity frequency. However, these large woofer arrays, e.g. 10 feet (112 Hz) to 56 feet (20 Hz), cannot fit into small rooms like a home, office, or recording studio.

Acousticians have published numerous Psychoacoustic studies that a full range constant directivity speaker has the highest listener preference and best articulation of consonant scores. Midrange/tweeter frequency constant directivity waveguides have been available since 1977 when Clifford Henrickson and Mark Ureda invented the Manta Ray horn. However, a compact and practical solution has not been available for bass frequencies.

In an attempt to solve the problems mentioned above, those in the art have used a number of different structures. However, the aforementioned issues continue to exist, which continue to present problems for speaker cabinets.

### SUMMARY

The present disclosure relates to novel and improved speaker assembly and cabinet designs that optimize audio quality and efficiency. Speaker assembly and cabinet designs according to the present disclosure can have an improved ability to precisely tune the desired audio range. For instance, speaker assemblies and cabinets herein can provide audio ranges that are consistent or linear with frequency and amplitude. In addition, speaker assemblies and cabinets described herein can provide a novel and improved manner in which to reduce or eliminate internal acoustic cavity resonance. Further, speaker assemblies and cabinets herein can construct and tune a compact woofer system with good efficiency that has a constant directivity pattern to match the constant directivity waveguide.

Embodiments according to the present disclosure can improve the overall audio output in speaker assemblies and cabinets through a novel layered component design. In some embodiments according to the present disclosure, speaker assemblies and cabinets can alternate layers of rigid and porous material. For example, speaker assemblies and cabinets herein can stack alternating layers of a rigid material and a porous damping material to cause aperiodic resonance damping. Speaker assemblies and cabinets of the present disclosure can also improve the directional pattern of the audio output, such as to provide a constant audio output at all frequencies. Further, speaker assemblies and cabinets herein can reduce or eliminate internal acoustic cavity resonance. As a result, the overall audio output at all frequencies can be improved.

Speaker assemblies and cabinets according to the present disclosure can also provide tunable or adjustable components for customizable audio preferences. In some embodiments of the present disclosure, the resonance frequency and damping may be optimized to fit specific audio needs. For example, the flow resistance of some speaker assembly and cabinet layers can be tuned or adjusted to shape the preferred audio output.

In some embodiments herein, different speaker assembly and cabinet layers may have individualized flow resistances in order to shape the directional frequency response. Moreover, speaker assemblies and cabinets according to the present disclosure can adjust each of the flow resistance, density, thickness, or shape of individual cabinet layers in order to achieve a desired directional audio output. Some embodiments according to the present disclosure can provide cabinet layers with a porous material that can be easily adjusted to specific characteristics to obtain a desired audio output. This adjustable and customizable capability of speaker cabinets herein has a number of advantages, including the ability to tailor cabinet designs to all different types of speakers. In addition, the ability to reduce or eliminate internal acoustic cavity resonance can provide a vastly improved overall audio output for speaker assemblies and cabinets according to the present disclosure.

One embodiment according to the present disclosure includes a speaker assembly comprising a cabinet that comprises a front opening, a plurality of first layers, and a plurality of second layers. The plurality of first layers can alternate with the plurality of second layers. A speaker driver can also be in a fixed position within the front opening. Also, the plurality of first layers can comprise a porous material.

Another embodiment according to the present disclosure includes a speaker cabinet comprising a front opening, a plurality of first layers on said front opening, and a plurality of second layers on the plurality of first layers. The plurality of first layers can alternate with the plurality of second layers. Additionally, the plurality of first layers can comprise a porous material.

In yet another embodiment, the present disclosure can include a speaker assembly comprising a cabinet that comprises a front opening, a plurality of first layers, and a plurality of second layers. The plurality of first layers can alternate with the plurality of second layers. Also, the speaker driver can be in a fixed position within the front opening. Moreover, a grille can be over the front opening.

These and other further features and advantages of the disclosure would be apparent to those skilled in the art from the following detailed description, taken together with the accompanying drawings, in which:

### BRIEF DESCRIPTION OF THE DRAWINGS

FIG. 1A is a top side perspective view of one embodiment of a speaker assembly according to the present disclosure;

FIG. 1B is a bottom side perspective view of the speaker assembly in FIG. 1A;

FIG. 1C is a front elevation view of the speaker assembly in FIG. 1A;

FIG. 1D is a rear elevation view of the speaker assembly in FIG. 1A;

FIG. 1E is a right side elevation view of the speaker assembly in FIG. 1A, the left side elevation view being a mirror image;

FIG. 1F is a top plan view of the speaker assembly in FIG. 1A;

FIG. 1G is a bottom plan view of the speaker assembly in FIG. 1A;

FIG. 1H is a sectional cut-out view of the speaker assembly in FIG. 1A.

FIG. 2A is a top side perspective view of another embodiment of a speaker assembly according to the present disclosure;

FIG. 2B is a bottom side perspective view of the speaker assembly in FIG. 2A;

FIG. 2C is a front elevation view of the speaker assembly in FIG. 2A;

FIG. 2D is a rear elevation view of the speaker assembly in FIG. 2A;

FIG. 2E is a right side elevation view of the speaker assembly in FIG. 2A, the left side elevation view being a mirror image;

FIG. 2F is a top plan view of the speaker assembly in FIG. 2A;

FIG. 2G is a bottom plan view of the speaker assembly in FIG. 2A;

FIG. 3A is a top side perspective view of a cabinet according to the present disclosure;

FIG. 3B is a bottom side perspective view of the cabinet in FIG. 3A;

FIG. 3C is a right side view of the cabinet in FIG. 3A;

FIG. 3D is a sectional cut-out view of the cabinet in FIG. 3A;

FIG. 4 is a perspective view of a front porous layer according to the present disclosure;

FIG. 5 is a perspective view of a middle porous layer according to the present disclosure;

FIG. 6 is a perspective view of a porous cabinet face according to the present disclosure;

FIG. 7 is a perspective view of a rear porous layer according to the present disclosure;

FIG. 8 is a perspective view of a rigid layer according to the present disclosure;

FIG. 9 is a perspective view of a front stand according to the present disclosure;

FIG. 10 is a perspective view of a rear stand according to the present disclosure;

FIG. 11 is a perspective view of a cabinet back according to the present disclosure;

FIG. 12 is a side view of a grille according to the present disclosure;

FIG. 13 is a perspective view of a positive terminal according to the present disclosure;

FIG. 14 is a perspective view of a negative terminal according to the present disclosure;

FIG. 15 is a perspective view of a driver assembly according to the present disclosure;

FIG. 16A is a top side perspective view of another embodiment of a speaker assembly according to the present disclosure;

FIG. 16B is a bottom side perspective view of the speaker assembly in FIG. 16A;

FIG. 16C is a left side view of the speaker assembly in FIG. 16A, the right side view being a mirror image; and

FIG. 16D is a sectional cut-out view of the speaker assembly in FIG. 16A.

### DETAILED DESCRIPTION

The present disclosure relates to novel and improved speaker assembly and cabinet designs that can optimize and improve audio quality and efficiency. Embodiments according to the disclosure herein can also have the ability to facilitate the precise tuning of audio range, as speaker assemblies and cabinets herein can be linear with frequency or amplitude. Some speaker assembly and cabinet embodiments according to the present disclosure can improve the overall audio output through a novel layered component design, such as by alternating layers of rigid and porous material. By doing so, speaker assemblies and cabinets herein can facilitate aperiodic resonance damping. Embodiments according to the present disclosure can provide a constant audio output at all frequencies and improve the audio output directional pattern. Moreover, speaker assembly and cabinet embodiments herein can vastly improve the overall audio output at all frequencies by reducing or eliminating internal acoustic cavity resonance.

Embodiments according to the present disclosure can also have the ability to customize the audio output by providing tunable or adjustable components, such as through the modification of the flow resistance, density, thickness, or shape of individual cabinet layers. This can also help to shape the directional frequency response, as well as adjust the damping or resonance frequency. In addition, the adjustable and customizable capability can allow assembly and cabinet designs herein to be tailored to all different types of speakers.

Components, assemblies, devices, designs, and mechanisms according to the present disclosure are described herein as being utilized with speakers, speaker assemblies, speaker cabinets, or enclosures. However, it is understood that assemblies, cabinets, or enclosures according to the present disclosure can be used in a wide variety of audio devices, including but not limited to speakers, as well as any device that utilizes or can benefit from utilizing a novel and improved audio design. It is also understood that any component in the assemblies, cabinets, and enclosures according to the present disclosure can utilize the novel and improved features described in the embodiments herein. Moreover, any individual component or combination of components described herein can be used in any appropriate design, device, or audio application.

Throughout this disclosure, the preferred embodiment and examples illustrated should be considered as exemplars, rather than as limitations on the present disclosure. As used herein, the term “invention,” “device,” “apparatus,” “method,” “disclosure,” “present invention,” “present device,” “present apparatus,” “present method” or “present disclosure” refers to any one of the embodiments of the disclosure described herein, and any equivalents. Furthermore, reference to various feature(s) of the “invention,” “device,” “apparatus,” “method,” “disclosure,” “present invention,” “present device,” “present apparatus,” “present method” or “present disclosure” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. In contrast, when an element is referred to as being “directly on” or extending “directly onto” another element, there are no intervening elements present. Additionally, it is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “inner,” “outer,” “upper,” “top,” “above,” “lower,” “bottom,” “beneath,” “below,” and similar terms, may be used herein to describe a relationship of one element to another. Terms such as “higher,” “lower,” “wider,” “narrower,” and similar terms, may be used herein to describe angular relationships. It is understood that these terms are intended to encompass different orientations of the elements or system in addition to the orientation depicted in the figures.

Although the terms first, second, third, etc., may be used herein to describe various elements, components, regions, or sections, these elements, components, regions, or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the present disclosure. As used herein, the terms “and,” “or,” or “and/or” can include any and all combinations of one or more of the associated list items. Also, any use of the terms “and” or “or” herein can also mean “and/or.”

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. For example, when the present specification refers to “an” assembly, it is understood that this language encompasses a single assembly or a plurality or array of assemblies. It is further understood that the terms “comprises,” “comprising,” “includes,” or “including” when used herein, specify the presence of stated features, integers, steps, operations, elements, or components, but do not preclude the presence or addition of one or more other features, integers, steps, operations, elements, components, or groups thereof.

Embodiments of the disclosure can be described herein with reference to view illustrations that are schematic illustrations. As such, the actual thickness of elements can be different, and variations from the shapes of the illustrations as a result, for example, of manufacturing techniques or tolerances are expected. Thus, the elements illustrated in the figures are schematic in nature and their shapes are not intended to illustrate the precise shape of a region and are not intended to limit the scope of the disclosure.

It is understood that while the present disclosure makes reference to assemblies, cabinets, or enclosures with novel and efficient designs, and that speakers may be the primary application concerned with the present disclosure, devices incorporating features of the present disclosure can be utilized with any application that has components or elements which might be concerned with audio designs, devices, mechanisms, or applications, or any similar application that may benefit from novel and efficient component design.

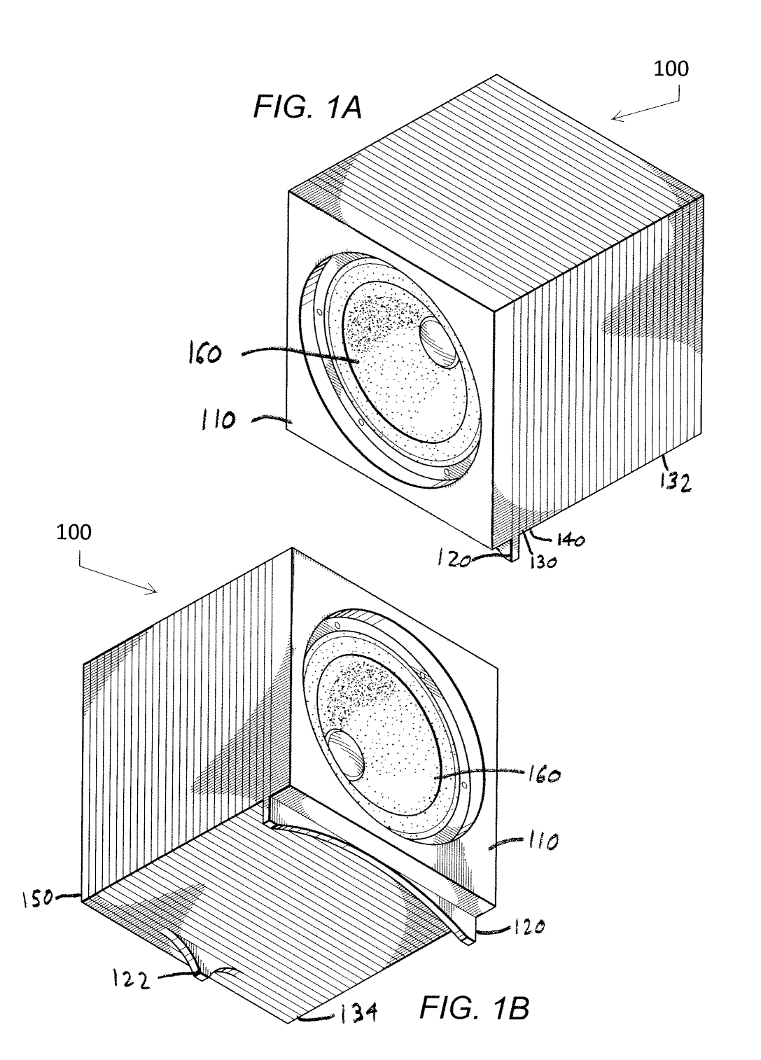

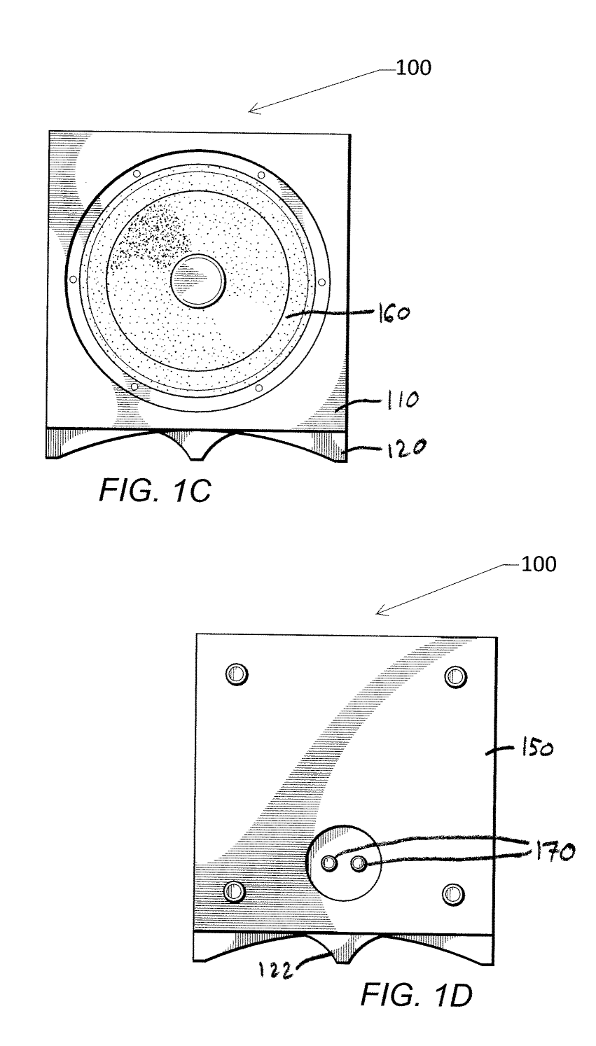

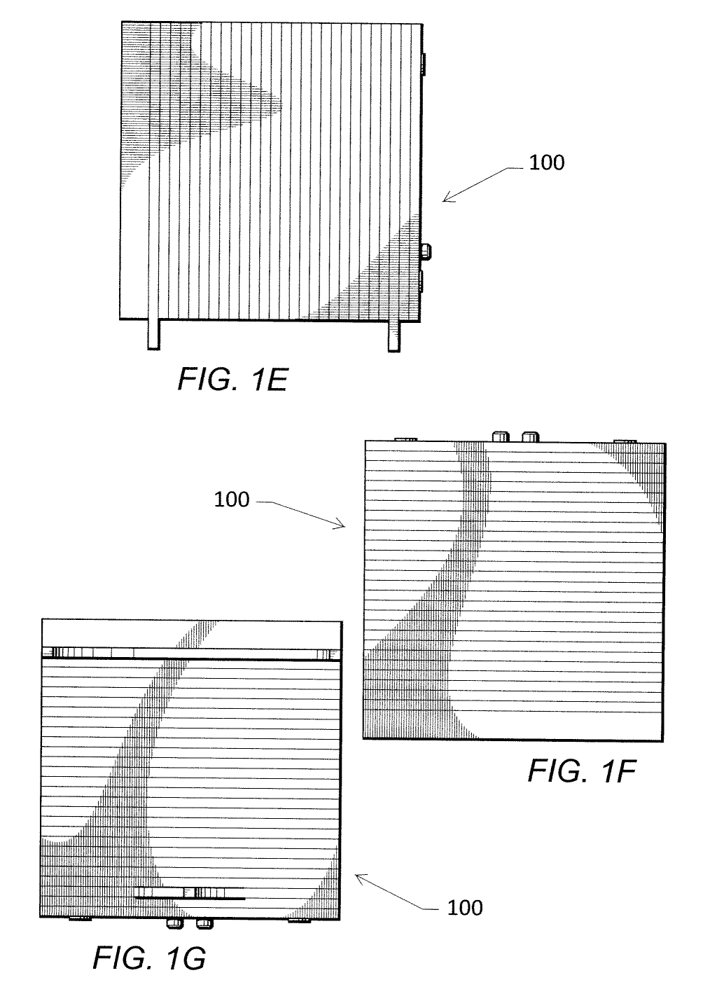

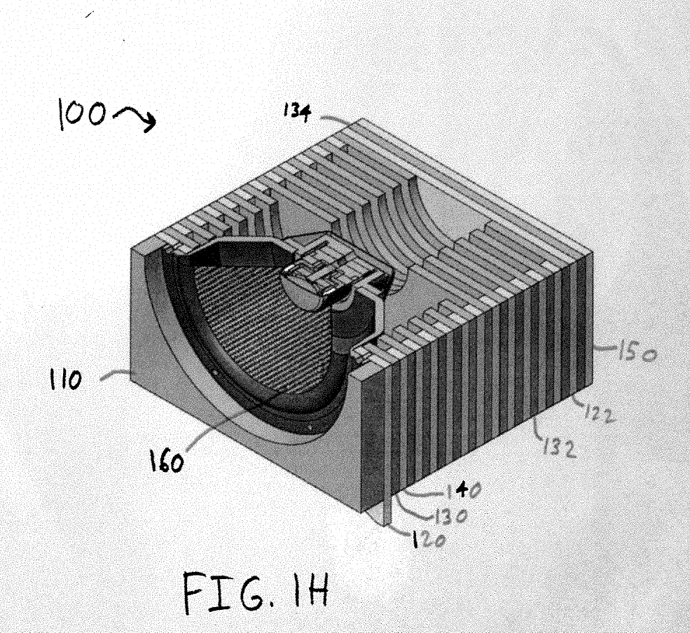

Embodiments according to the present disclosure can comprise speaker assemblies and cabinets with novel and improved designs. FIG. 1A displays one embodiment of speaker assembly 100, which comprises many of the novel and improved features described herein. Speaker assembly 100 can have features that optimize and improve audio quality and efficiency. Speaker assembly 100 can also facilitate the precise tuning of audio range, such as the ability to customize the audio output by providing tunable or modifiable components to adjust the damping or resonance frequency. Moreover, speaker assembly 100 can facilitate aperiodic resonance damping, as well as provide a constant audio output at all frequencies and improve the audio output directional pattern. Additionally, speaker assembly 100 can improve the overall audio output at all frequencies by reducing or eliminating internal acoustic cavity resonance.

Speaker assemblies according to the present disclosure can comprise a variety of different components. FIGS. 1A-1H display speaker assembly 100 which comprises several different components, such as cabinet face 110, front stand 120, front porous layer 130, rigid layer 140, middle porous layer 132, rear stand 122, rear porous layer 134, and cabinet back 150. Speaker assembly 100 can also comprise a number of different components, such as driver 160 and terminals 170.

The relative position of each component within speaker assembly 100 is also important. Accordingly, FIG. 1H provides a sectional cut-out view of the relative component positions of speaker assembly 100. For instance, FIG. 1H identifies the location of each of the individual components with respect to the speaker assembly 100 as a whole.

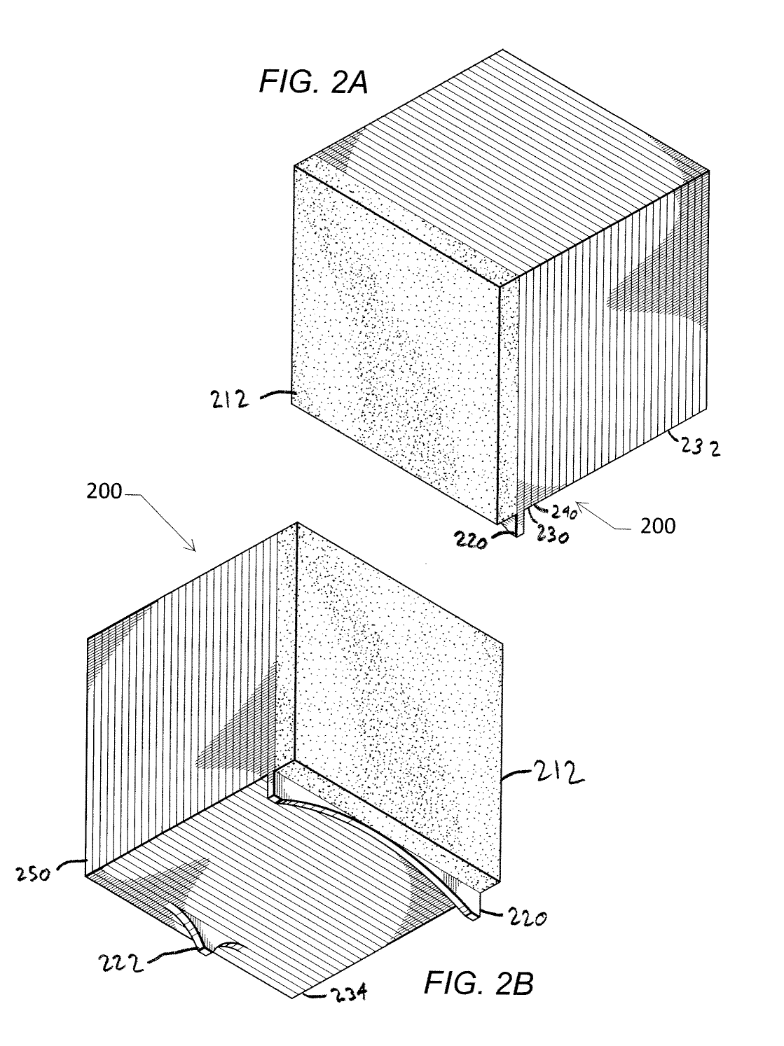

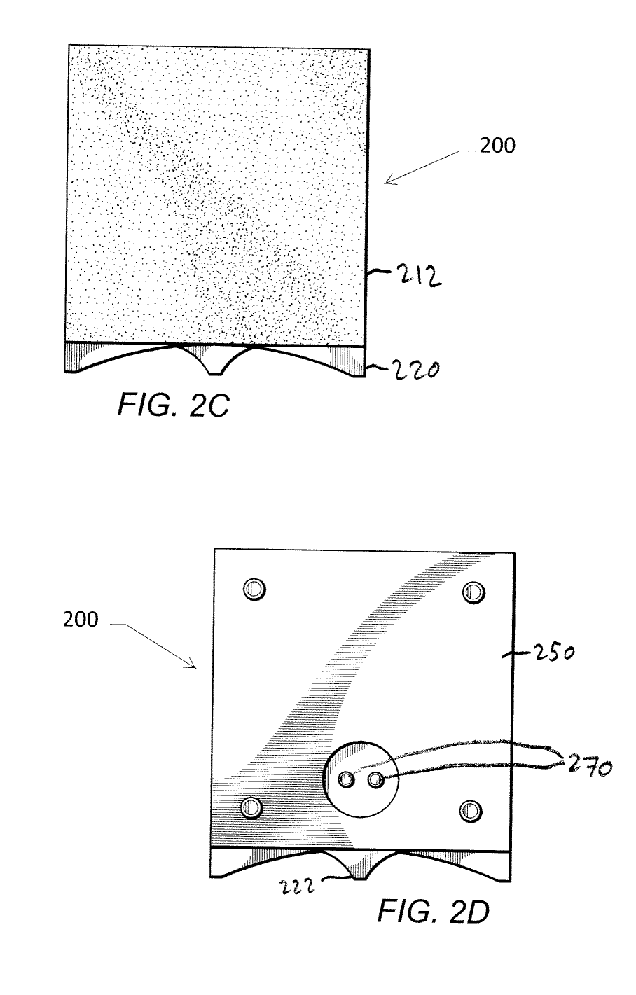

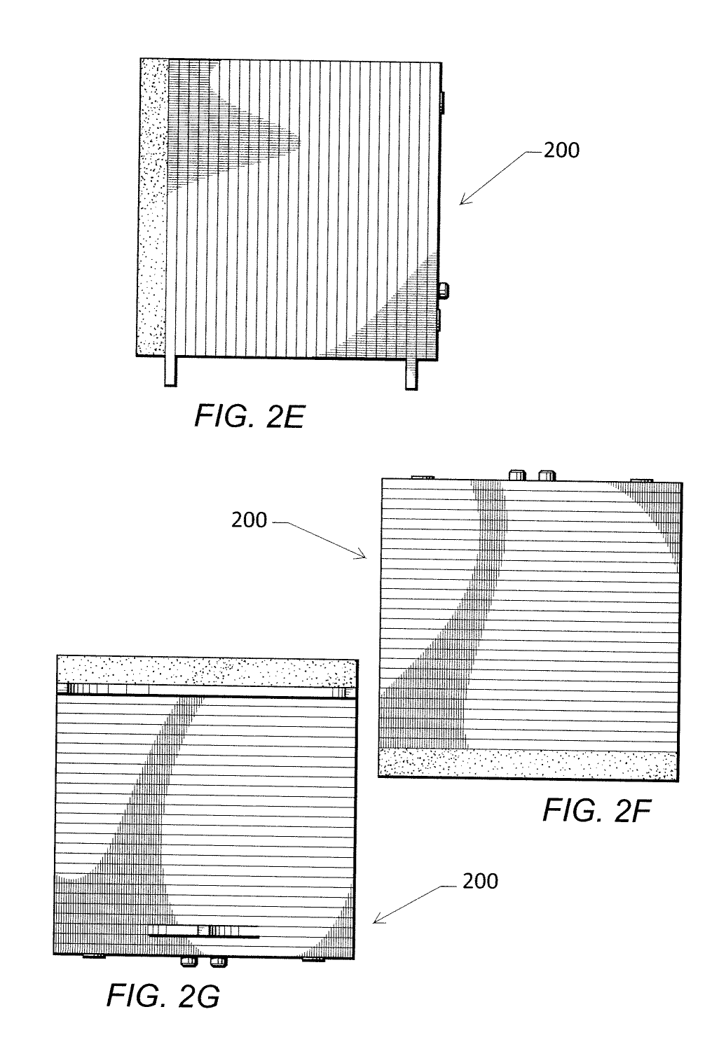

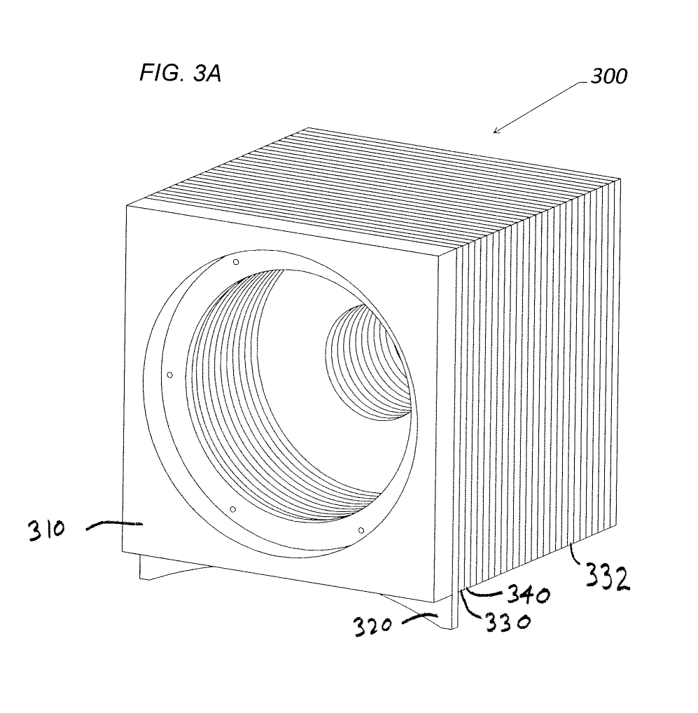

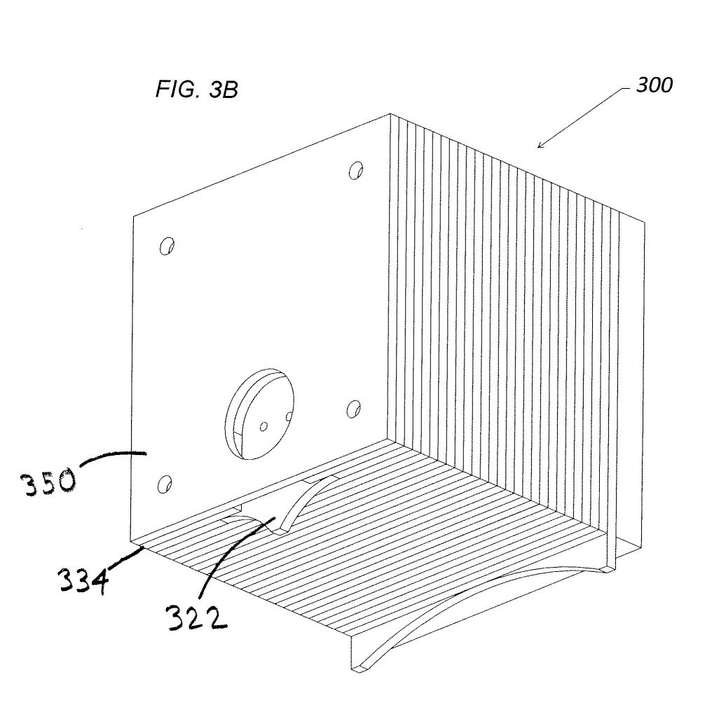

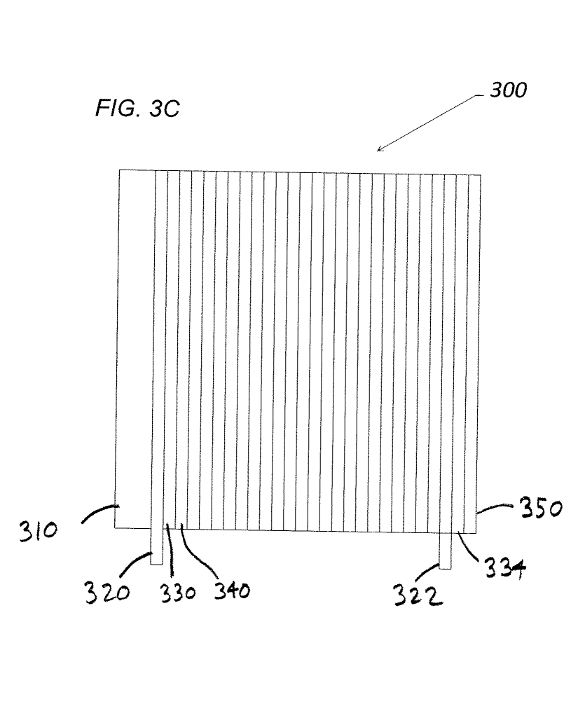

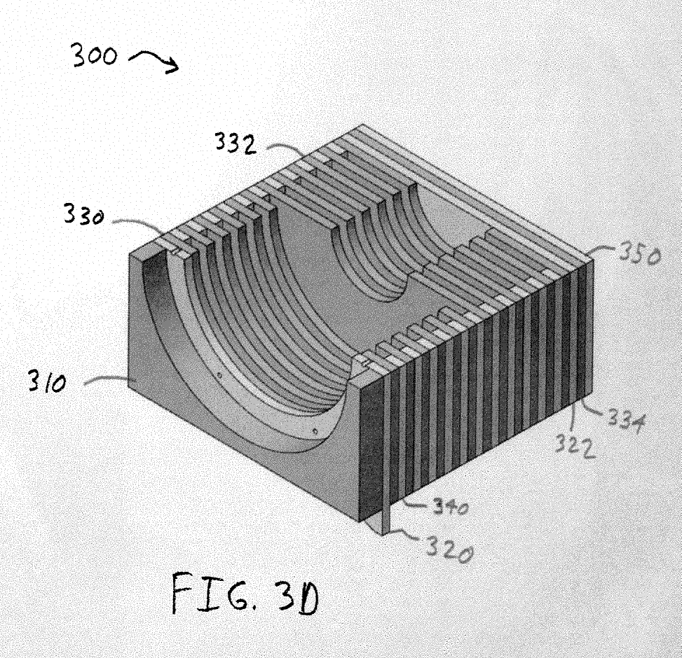

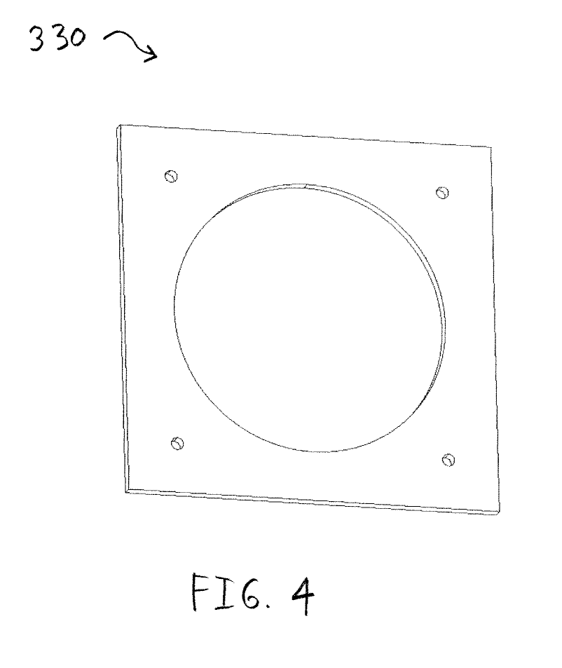

Embodiments according to the present disclosure can have a variety of different speaker assemblies and cabinets. FIGS. 2A-2G provide several different views of another speaker assembly 200 according to the present disclosure. As shown in FIGS. 2A-2G, speaker assembly 200 is similar to speaker assembly 100, but it comprises some additional components, such as grille 212. In addition, speaker assembly 200 comprises cabinet face (not shown), front stand 220, front porous layer 230, rigid layer 240, middle porous layer 232, rear stand 222, rear porous layer 234, and cabinet back 250. Speaker assembly 100 also comprises driver (not shown) and terminals 270.

Grille 212 can provide several advantages to speaker assembly 200. For instance, grille 212 can prevent foreign objects from entering speaker assembly 200. Accordingly, grille 212 can function as a type of protective device for speaker assembly 200. And importantly, grille 212 can still allow sound to clearly emit from speaker assembly 200.

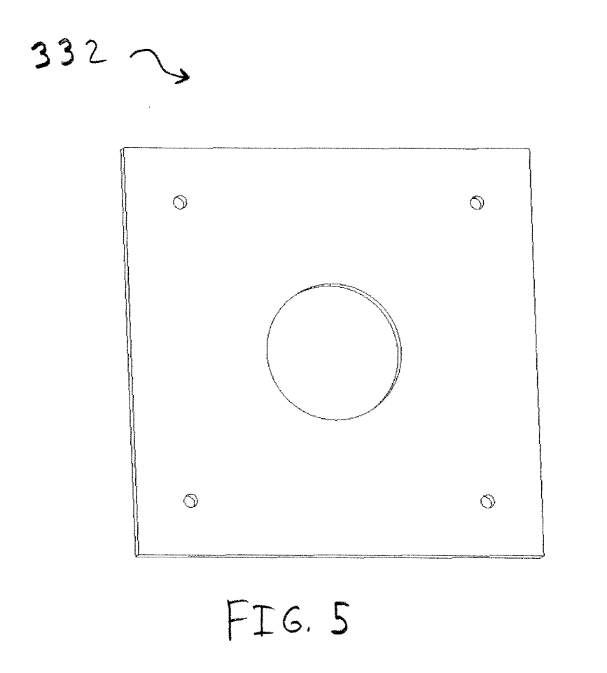

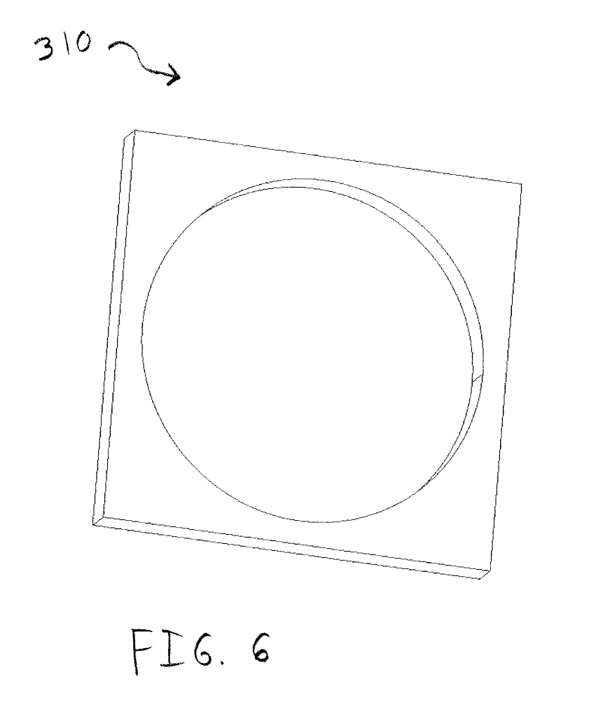

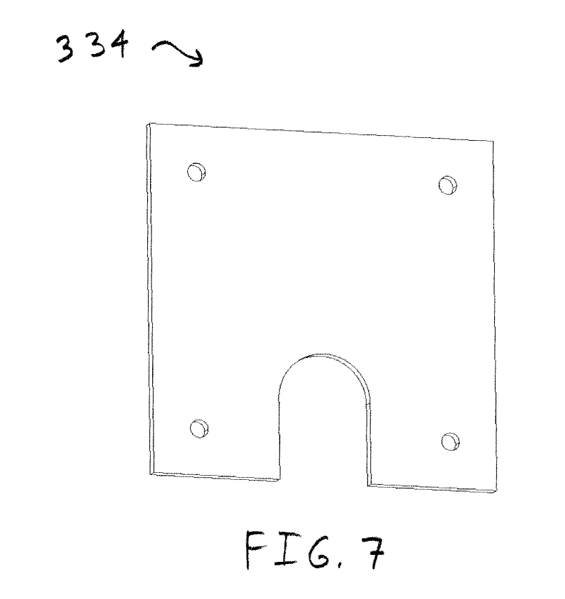

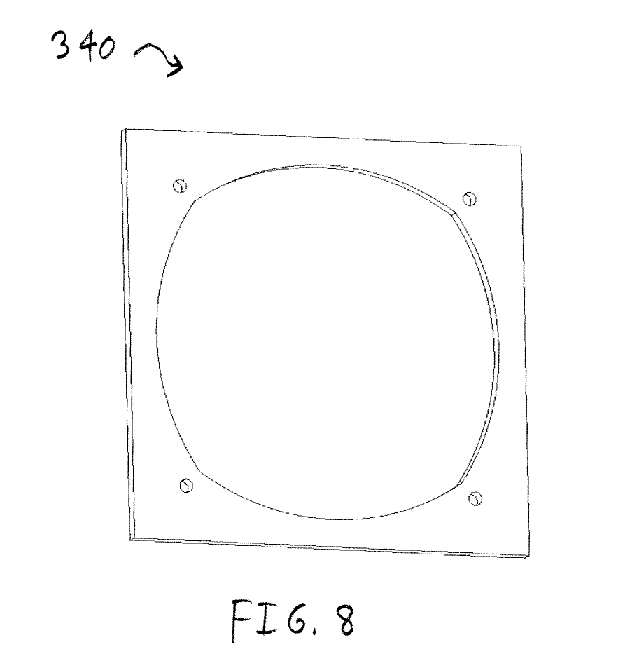

Embodiments according to the present disclosure can also comprise components that are versatile and can be used in a number of different settings. For instance, embodiments described herein can comprise cabinets and enclosures, such that they can be used with a wide variety of speakers or drivers. FIGS. 3A-3D display one such cabinet 300 according to the present disclosure. Cabinet 300 comprises cabinet face 310, front stand 320, front porous layer 330, rigid layer 340, middle porous layer 332, rear stand 322, rear porous layer 334, and cabinet back 350.

As referenced above, the relative position of each component within cabinet 300 is important, so FIG. 3D provides a sectional cut-out view of the relative component positions of cabinet 300. FIG. 3D helps to identify the location of each of the individual components or layers with respect to the cabinet 300 as a whole.

Cabinet 300 has a number of novel and improved features that can optimize audio quality and efficiency. For instance, cabinet 300 can provide a novel and improved manner in which to reduce or eliminate internal acoustic cavity resonance. Cabinet 300 can also facilitate aperiodic resonance damping and provide a constant audio output at all frequencies. Furthermore, cabinet 300 can improve the audio output directional pattern and precisely tune the audio output range. For example, cabinet 300 can have the ability to customize the audio output by providing tunable and modifiable components in order to adjust the damping or resonance frequency. In this manner, cabinet 300 can provide audio ranges that are consistent or linear with frequency and amplitude.

Cabinet 300 can also provide tunable or adjustable components for customizable audio preferences. In some embodiments, cabinet 300 can optimize the resonance frequency or damping to fit specific audio needs. For example, the flow resistance of some cabinet 300 layers with a porous material can be tuned or adjusted to shape a preferred audio output. In some embodiments, different layers in cabinet 300 may have individualized flow resistances in order to shape the directional frequency response. Moreover, the flow resistance, density, thickness, and/or shape of individual cabinet layers can be adjusted in order to achieve a desired directional audio output. This adjustable or customizable capability of cabinet 300 fosters the ability to tailor designs to all different types of speakers.

Cabinet 300 can improve the overall audio output through a novel layered component design. As shown in FIGS. 3A-3D, some embodiments of cabinet 300 can stack alternating layers of a rigid material and a porous damping material, which can facilitate aperiodic resonance damping. For example, front porous layer 330 and rigid layer 340 can alternate with one another near the front of cabinet 300, while middle porous layer 332 and rigid layer 340 can alternate near the rear of cabinet 300. By alternating layers of rigid and porous material, cabinet 300 can be aperiodic in nature, so there are no internal pressure nodes that can cause resonance. As a result, cabinet 300 can reduce or eliminate internal acoustic cavity resonance at all frequencies. By doing so, cabinet 300 can improve the overall audio output at all frequencies.

As mentioned above, embodiments of cabinet 300 can have an aperiodic enclosure. Aperiodic designs in embodiments of cabinet 300 can have a number of different resonance dampening advantages. For example, aperiodic designs of cabinet 300 can have very good low frequency dampening capabilities. Some embodiments of cabinet 300 can include an aperiodic enclosure with a resistively dampened air leak. By doing so, the size and weight of cabinet 300 can be smaller than conventional sealed or vented cabinets.

Alternating layers of rigid and porous material can also allow cabinet 300 to have a large or precise tuning range, such that cabinet 300 can emit audio output that is linear with frequency and amplitude. Further, the directional adjustment range of cabinet 300 can be tunable, in order to provide constant directivity at all frequencies. In some embodiments of cabinet 300, the directional adjustment range can also fall be between omnidirectional and dipole, which emits a front-to-back “figure 8” radiation pattern with null side radiation, wherein a preferred embodiment is cardioid-like.

A cardioid radiation pattern emits in a heart-like shape, which is functionally similar to a dipole radiation pattern that has different volume on the front side and back side. Embodiments of cabinet 300 that emit cardioid radiation patterns can have directional control at all frequencies. In turn, this can provide cabinet 300 a number of different advantages, including but not limited to reducing acoustic resonance, energy direction control, or reducing size and weight. Some embodiments of cabinet 300 can construct a cardioid enclosure by causing cabinet back 350 to have a controlled acoustic “leak,” which can partially cancel any undesired sound on the sides and/or rear. This enclosure construction can be similar to an aperiodic design, but with a strategic geometric placement of the air leak or a strategic adjustment of the air leak to control volume and damping.

Embodiments of cabinet 300 can have a number of different shapes, sizes, or designs. Indeed, the internal and external geometric shapes, sizes, or designs of cabinet 300 have no restrictions. For example, the cabinet 300 shape can be a cube or rectangle, or something more complex such as a sphere or artistic three dimensional shape. The shape of cabinet 300 can also be asymmetric in any direction. Additionally, the internal and external geometries of cabinet 300 can be different. For example, one embodiment of cabinet 300 can include an external geometry of an egg and an internal geometry of a sphere. Moreover, the walls and layers of cabinet 300 can have variable thicknesses, which can in turn allow cabinet 300 to facilitate the tuning of the damping or directivity.

The shapes, sizes, or designs of embodiments of cabinet 300 can also have a number of audio advantages. In one embodiment, cabinet 300 can simulate the advantages of several different types of speakers, such as a woofer, horn, or waveguide. For instance, cabinet 300 can match the output of a woofer to the directivity of a horn or waveguide, such that the entire frequency bandwidth can have a controlled directivity. In turn, this can improve the RT60 or articulation of consonants. In other embodiments, the enclosure of cabinet 300 can be tuned to match the high directivity of horns or waveguides and the low directivity of dome tweeters.

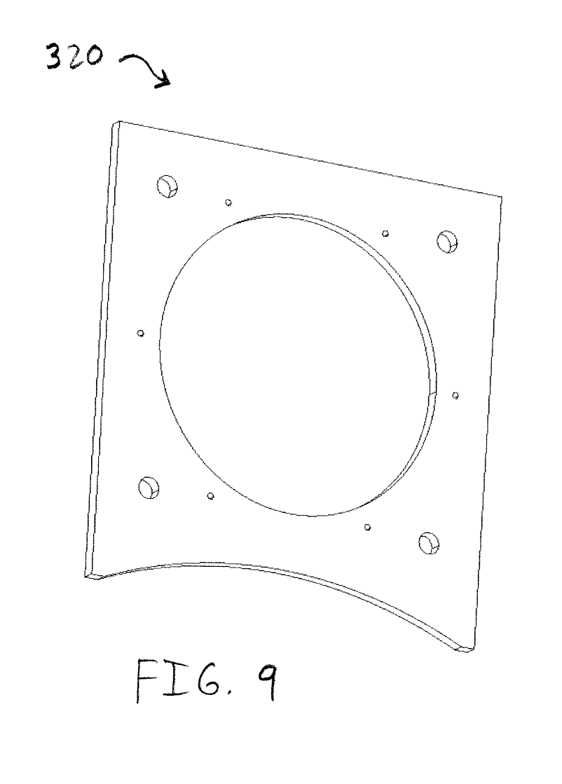

Embodiments of cabinet 300 can also include a number of different layers that contribute to the novel and improved features discussed herein. These layers of cabinet 300 can comprise a number of different materials, including but not limited to porous materials. FIGS. 4 and 5 display front porous layer 330 and middle porous layer 332, respectively, which can each comprise the novel and improved features. For instance, front porous layer 330 or middle porous layer 332 can contribute to facilitating aperiodic resonance damping, as well as reducing or eliminating internal acoustic cavity resonance. Additionally, front porous layer 330 or middle porous layer 332 can improve the audio output directional pattern and provide a constant audio output at all frequencies. One manner in which front porous layer 330 or middle porous layer 332 can accomplish these features is the ability to precisely tune the audio output range.

As shown in FIGS. 4 and 5, front porous layer 330 can be shaped differently from middle porous layer 332. For example, front porous layer 330 can comprise a larger opening than middle porous layer 332 (also shown in FIG. 3D). This can be for a number of different reasons, such as to fit the shape of other components, such as speaker drivers. However, it is understood that front porous layer 330 and middle porous layer 332 can include any number of appropriate shapes, including those similar to, or different from, one another. Additionally, front porous layer 330 or middle porous layer 332 can be referred to by a number of different terms, including but not limited to porous layer, porous material, air porous layer, or air porous material, as well as any other appropriate term.

As mentioned above, the flow resistance of front porous layer 330 or middle porous layer 332 can be tuned or adjusted. By doing so, the speaker resonance frequency or damping can be optimized. Moreover, the flow resistance, density, thickness, or shape of porous layers 330/332 can be adjusted in order to achieve the aforementioned cardioid directional energy response. Additionally, each layer in porous layers 330/332 can have a different flow resistance, in order to shape the directional frequency response. Moreover, the flow resistance of porous layers 330/332 can be adjusted by using different materials, densities, thickness, and/or shapes.

The density of porous layers 330/332 can be adjusted in a number of different manners, such as by altering the material specification. For example, F10 felt can be adjusted to F26 felt, or ½ pound acoustic foam can be adjusted to 2 pound acoustic foam. The density of porous layers 330/332 can also be adjusted by taking a low density material, such as foam or fiberglass, and compressing the thickness between the layers of a more rigid material, for example in a vise-like fashion. Embodiments according to the present disclosure can also implement a mechanism to allow for adjusting the compression density of porous layers 330/332.

The thickness, shape, or density of porous layers 330/332 can be adjusted as necessary to yield the desired tuning or audio characteristics, such as the frontal frequency response or the directional frequency response. Adjusting the thickness and/or density of porous layers 330/332 can change the flow resistance or damping, as well as the resultant directional frequency response. Moreover, altering the shape, location, or area of porous layers 330/332 can change the total amount of acoustic energy that leaks through the walls of cabinet 300, which can be used to reduce volume on the sides and/or rear of cabinet 300. For comparison purposes, the system efficiency of cabinet 300 can be much higher than a dipole and the size/weight can be less than a sealed cabinet.

Porous layers 330/332 can be any thickness or dimension that is appropriate to the desired tuning or cosmetics. In one embodiment, porous layers 330/332 can be ¼ inches thick, while in other embodiments porous layers 330/332 can be 1/2 , 1, 1.5, or even 2 inches thick. However, it is understood that porous layers 330/332, or any other layer in cabinet 300, can be any appropriate thickness, shape, or dimension.

As mentioned above, porous layers 330/332 can facilitate aperiodic resonance damping, which can be a controlled air leak that has a controlled resistive element for damping. Essentially, damping can be caused by aerodynamic drag resistance as the sound energy transverses the porous layers 330/332. As porous layers 330/332 each comprise a porous material, air can leak through the material and cause damping. This air leak in porous layers 330/332 can reduce the air spring strength, effectively making the volume of cabinet 300 appear to be larger than it actually is.

Additionally, the flow resistance of porous layers 330/332 can be adjusted to shape the directional frequency response. The sound that leaks through the porous layers 330/332 can also partially cancel any sound on the front side of cabinet 300, which changes the directivity or frequency response. Tuning the damping of the porous layers 330/332 can adjust the volume of the sound leaking through the porous layers 330/332. Specifically, the porous surface area or porous density of porous layers 330/332 can be adjusted to control the frequency or volume of any sound leaking through. Depending on the tuning goal, the flow resistance in adjacent layers can be identical or different. Moreover, the air leak in porous layers 330/332 can be controlled, as too much air leak can harm efficiency. A tuned amount of air leak can also be used to adjust the directivity or shape of frequency response.

As mentioned above, altering the flow resistance of porous layers 330/332 can affect the acoustic leakage. For instance, a low density porous material has less surface reflection, but also less sound energy absorption, so it can be wider. Conversely, a high density porous material may have too much surface reflection, but it can absorb more sound energy, so it can be thinner. Further, low density materials can be used for high frequencies, while high density materials can be used for low frequencies. In order to have a broad and flat frequency response, porous layers 330/332 can have a medium or variable density porous material.

Many different types of flow resistances can be used for porous layers 330/332, depending on the corresponding type of speaker. For example, SAE F10 wool felt, for example ¼ inch thick by 1 inch wide, can be useful for speakers 70 Hz to 20 kHz. For speakers lower in frequency, more width can be used. SAE F10 wool felt can be superior to acoustic foam for a flat frequency response or a minimum required thickness. Cotton felt can also be useful for these applications.

Front porous layer 330 or middle porous layer 332 can comprise any appropriate material including felt, animal hair, wool, plant fibers, cotton, cellulose, plastic, synthetic fibers, and/or glass fibers. Additionally, porous layers 330/332 can comprise a compressed insulation material, fiberglass, rock wool, or any the above materials, as well as woven or knitted cloth, or open cell foam. When open cell foam is used in porous layers 330/332, foam pore size can be adjusted to alter the damping or flow. Porous layers 330/332 can also comprise a rigid material that has internal passages or channels with significant air flow resistance such as foams comprising plastic, rubber, metal, ceramic, cellulose, perlite, and/or volcanic rocks. Additionally, any porous material can be used in porous layers 330/332 that has the necessary characteristics of strength, damping, air flow volume, or linearity. It is understood that porous layers 330/332 can comprise any number of appropriate materials, including but not limited to those discussed herein.

Cabinet 300 can also include other layers that comprise a porous material. FIGS. 6 and 7 display cabinet face 310 and rear porous layer 334, respectively. As shown herein, cabinet face 310 can be at the front end of cabinet 300, while rear porous layer 334 can be at the rear end of cabinet 300. Cabinet face 310 or rear porous layer 334 can comprise characteristics that are similar to those found in front porous layer 330 or middle porous layer 332 mentioned above, including but not limited to all of the novel and improved features mentioned herein.

Cabinet face 310 or rear porous layer 334 can also comprise materials similar to those mentioned above, including but not limited to felt, compressed insulation material, fiberglass, rock wool, animal hair, plant fibers, cotton, cellulose, synthetic fibers, or glass fibers, as well as woven or knitted cloth, or open cell foam. Cabinet face 310 or rear porous layer 334 can also comprise foam, plastic, rubber, metal, ceramic, cellulose, perlite, or volcanic rocks. It is understood that cabinet face 310 or rear porous layer 334 can comprise any number of appropriate materials, including but not limited to those discussed herein.

Embodiments according to the present disclosure can utilize rigid layers to alternate with porous material layers. FIG. 8 displays one such rigid layer 340. As shown herein, cavity 300 can comprise alternating layers of rigid layer 340 and porous layers 330/332. Indeed, cavity 300 embodiments according to the present disclosure can comprise a plurality of rigid layers 340.

Rigid layers 340 herein can be any number of different sizes or shapes. Embodiments according to the present disclosure can include rigid layers 340 that are the same or similar size, while front porous layer 330 or middle porous layer 332 are different sizes. Indeed, rigid layers 340 and porous layers 330/332 do not need to be the same size or shape. For example, rigid layers 340 might be square and the porous layers 330/332 could be circular or star shaped. Furthermore, the edge alignment of rigid layers 340 and porous layers 330/332 can be smooth, stair step, or randomly patterned. Moreover, rigid layers 340 and porous layers 330/332 can be oriented in any direction, e.g. front to back, side to side, top to bottom, diagonal, or any direction. And rigid layers 340 do not need to be parallel or straight in comparison to porous layers 330/332. For example, rigid layers 340 and porous layers 330/332 can be shaped like a wedge or curved like a wave.

Each layer of rigid layer 140 and porous layers 330/332 can be a different thickness as necessary for tuning or desired cosmetics. In one embodiment, the rigid layers 140 can be ¼ inches thick and the porous layers 330/332 can be ¼ inches thick. In other embodiments, the layers can be asymmetric, e.g. ¾ inch thick rigid layers 140 and ½ inch thick porous layers 330/332, ¼ inch thick rigid layers 140 and 1.5 inch thick porous layers 330/332, as well as a number of different thickness combinations. The thickness/shape of rigid layers 140 and the thickness/shape/density of porous layers 330/332 can be adjusted as necessary to yield the desired frontal frequency response or desired directional frequency response.

As mentioned above, rigid layers 140 alternating with porous layers 330/332 can cause cabinet 300 to be aperiodic in nature. Specifically, air leaks through porous layers 330/332, which can reduce pressure build up. As porous layers 330/332 are flexible, the ridged layers 140 are necessary to constrain the porous layers 330/332 and prevent sympathy vibration from the air pressure inside generated by a speaker. Constraining damping material movement can force linear flow resistance at all frequencies and amplitudes. In turn, this helps to reduce or eliminate internal pressure nodes that can cause acoustic cavity resonance. Accordingly, the alternating of rigid and porous materials can improve the overall audio output by reducing or eliminating acoustic cavity resonance.

Rigid layers 340 according to the present disclosure can comprise a number of different materials, including wood, metal, plastic, composite, glass, rock, elastomer, polymer, and/or paper. It is understood that rigid layers 340 can comprise any number of appropriate materials, including but not limited to those discussed herein.

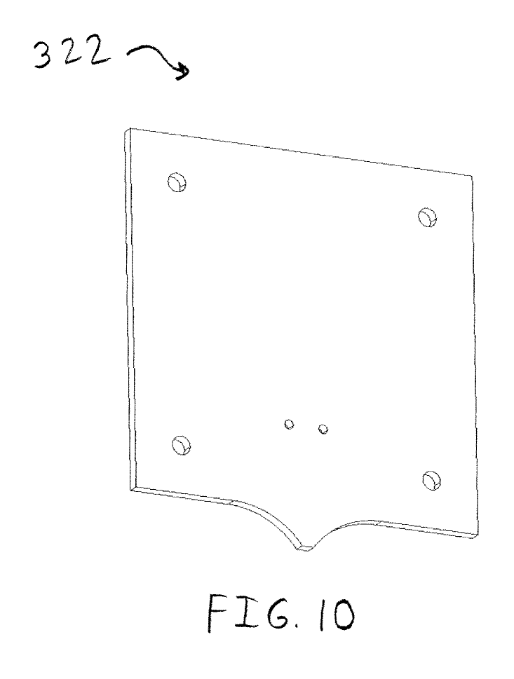

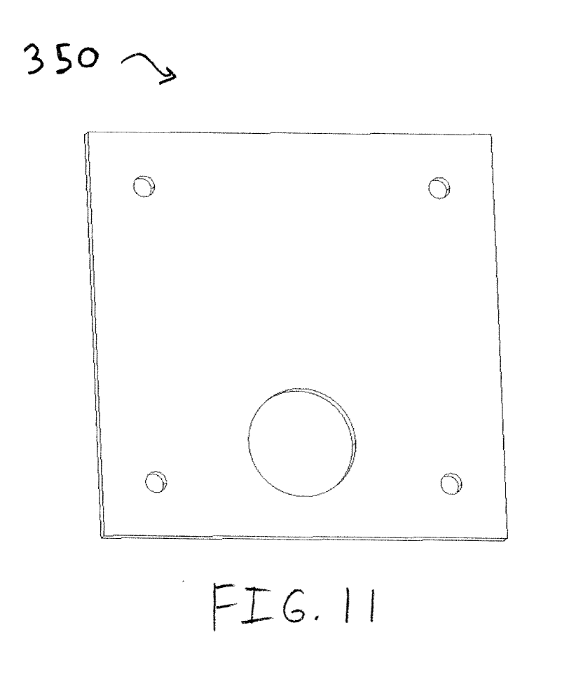

Cabinet 300 can also include other layers that comprise a rigid material. FIGS. 9-11 display front stand 320, rear stand 322, and cabinet back 350, respectively. As shown herein, front stand 320 can be at the front end of cabinet 300, rear stand 322 can be near the rear end of cabinet 300, and cabinet back 350 can be at the back of cabinet 300. Front stand 320, rear stand 322, and cabinet back 350 can comprise characteristics that are similar to those found in rigid layers 340 mentioned above, including but not limited to each of the features mentioned herein.

Front stand 320, rear stand 322, and cabinet back 350 can comprise a number of different materials, including wood, metal, plastic, composite, glass, rock, elastomer, polymer, and/or paper. However, it is understood that front stand 320, rear stand 322, and cabinet back 350 can comprise any number of appropriate materials, including but not limited to those discussed herein.

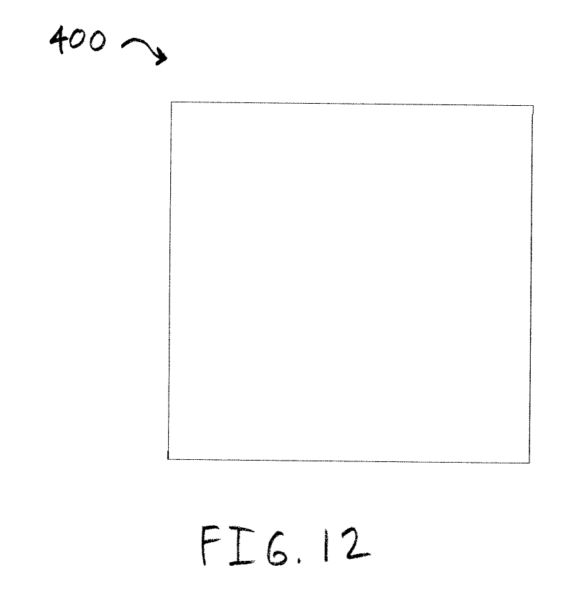

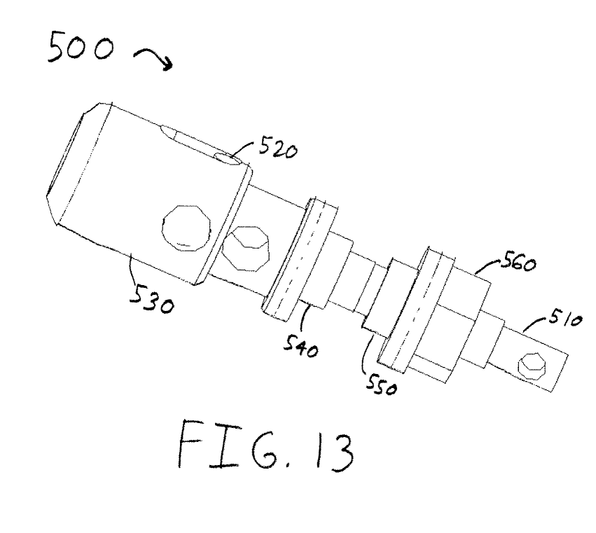

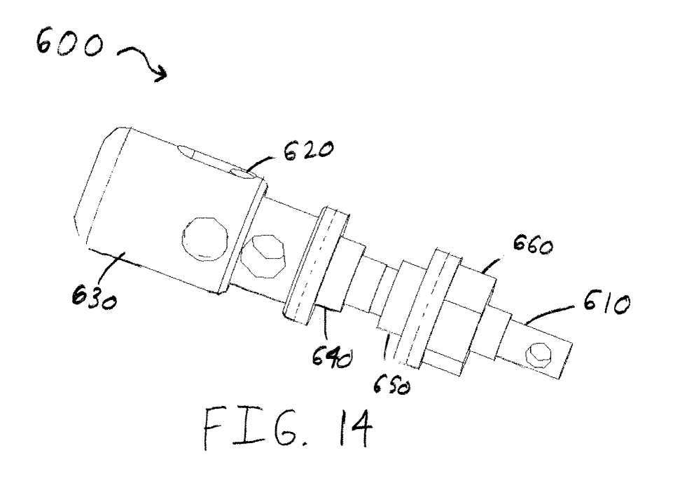

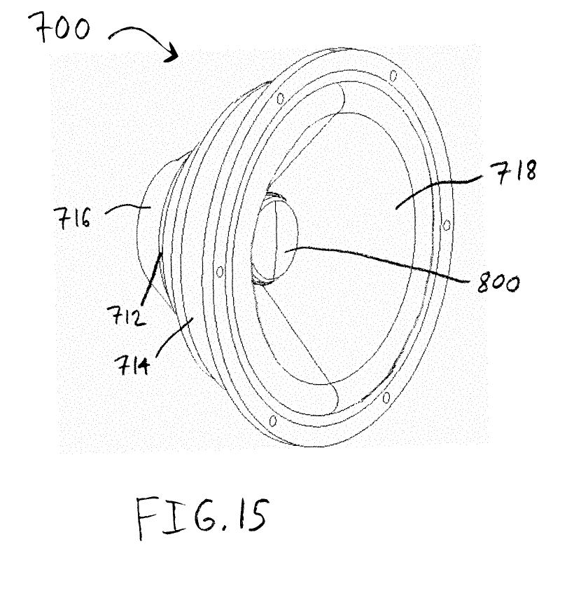

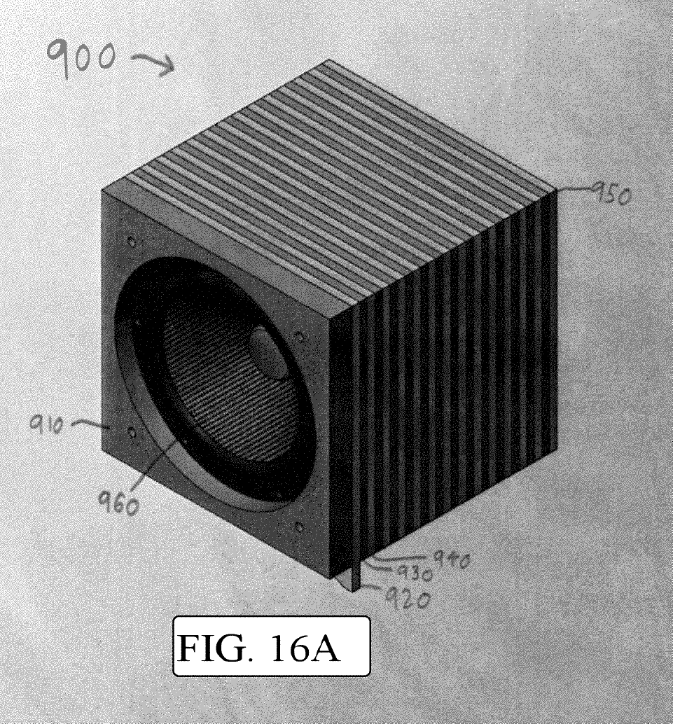

Embodiments according to the present disclosure can also comprise different components used for protective purposes. FIG. 12 displays grille 400. Grille 400 can provide several advantages to the speaker assemblies according to the present disclosure. For instance, grille 400 can prevent foreign objects from entering speaker assemblies herein. Accordingly, grille 400 can function as a type of protective device. Yet grille 400 can still allow sound to clearly emit from the speaker assemblies. It is understood that grille 400 and other grilles according to the present disclosure can comprise any number of appropriate materials that can protect against foreign objects and/or allow sound to clearly emit through it.

Embodiments according to the present disclosure can also comprise positive and negative terminals. FIGS. and 14 display positive terminal 500 and negative terminal 600, respectively. Positive terminal 500 comprises base 510, pin 520, cap 530, top bushing 540, bottom bushing 550, and nut 560. Likewise, negative terminal 600 comprises base 610, pin 620, cap 630, top bushing 640, bottom bushing 650, and nut 660. It is understood that terminals according to the present disclosure can comprise any number of appropriate materials, designs, or dimensions.

Embodiments according to the present disclosure can also comprise speakers or drivers. FIG. 15 displays driver assembly 700. Driver assembly 700 can comprise upper cap 702, lower cap 704, ring 706, magnet 708, voice coil 710, cup 712, basket 714, cover 716, cone 718, and tweeter assembly 800. The woofer can also be separate from the tweeter. A separate tweeter can be used with or without a waveguide to control directivity.

Driver assembly 700 can comprise a number of the novel and improved features mentioned herein. For instance, driver assembly 700 can be tuned or adjusted to take advantage of the unique enclosure acoustics. As mentioned above, aperiodic dampening can reduce internal air pressure and/or increase dampening. As speaker assemblies and cabinets according to the present disclosure can experience aperiodic dampening, this can allow driver assembly 700 to be designed with a lower moving mass for higher efficiency or a lower damping as measured by a higher Qt. A higher Qt can be achieved with a smaller magnet, but this can also reduce efficiency. A better way to raise Qt is with fewer layers of wire or lighter weight aluminum wire on the voice coil, which can lower mass and increase efficiency. Fewer voice coil layers can also reduce inductance, extend high frequency response and reduce intermodulation distortion. Lower internal air pressure can also reduce stress on the cone, so the cone can be thinner and/or lighter weight to increase efficiency.

As also mentioned above, the side dampened air leak can use partial acoustic cancellation to form a cardioid-like directivity. This partial acoustic cancellation can also reduce the low frequency efficiency. Low frequency partial acoustic cancellation can be compensated for by driver assembly 700 having a suitable higher Qts. Because of acoustic cancellation, a dipole driver can have a damping or Qts of around 2.5 to yield a flat summed acoustic frequency response. To compensate for enclosure damping or wall leak, an optimized driver can have a Qts between 0.5 and 2.0 to yield a flat summed acoustic frequency response. In our testing we have confirmed this tuning ability. A woofer with free air Qts=1.2 inside the tuned enclosure had resulting impedance curve of Qtc=0.55 and resulting frequency response shape of Qtc=0.55.

The damping or Qts of driver assembly 700 and the side/rear air leak or damping can be adjusted in a complementary manner, so that the summed acoustic result can have a preferred frequency response shape. For instance, the summed acoustic result can have a preferred frequency response shape that looks similar to damping or Qtc between 0.5 and 1.2. As a reference, the ideal damping or Qtc can be somewhere around 0.7 for flattest frequency response or around 0.5 for fastest damping decay time.

Embodiments according to the present disclosure can also comprise different types of speakers, such as tweeters. As mentioned above, FIG. 15 displays tweeter assembly 800. Tweeter assemblies according to the present disclosure can comprise a number of different components, such as a back cup, magnet, top plate, mount cup, butterfly, positive terminal, negative terminal, bobbin, voice coil, inverted dome, suspension, grille, left tensile wire, right tensile wire, and/or plug.

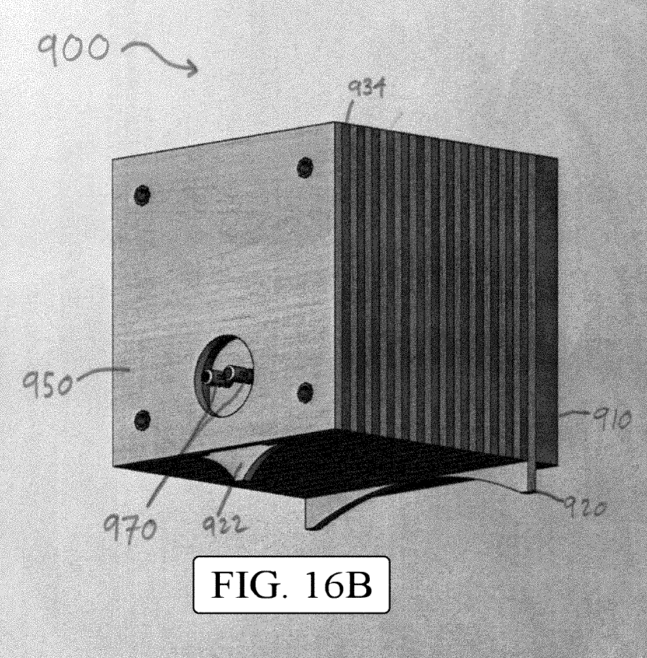

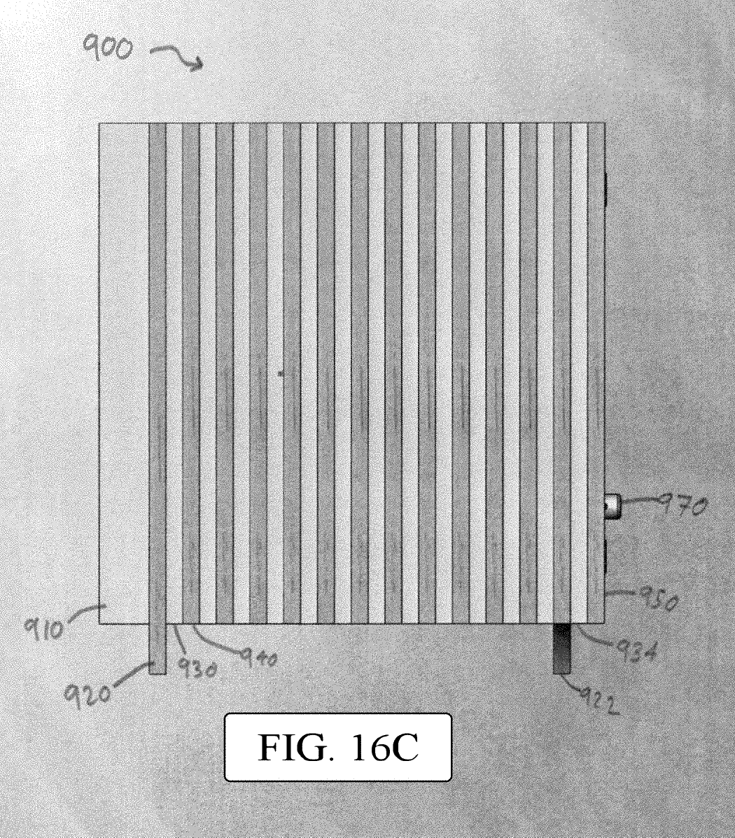

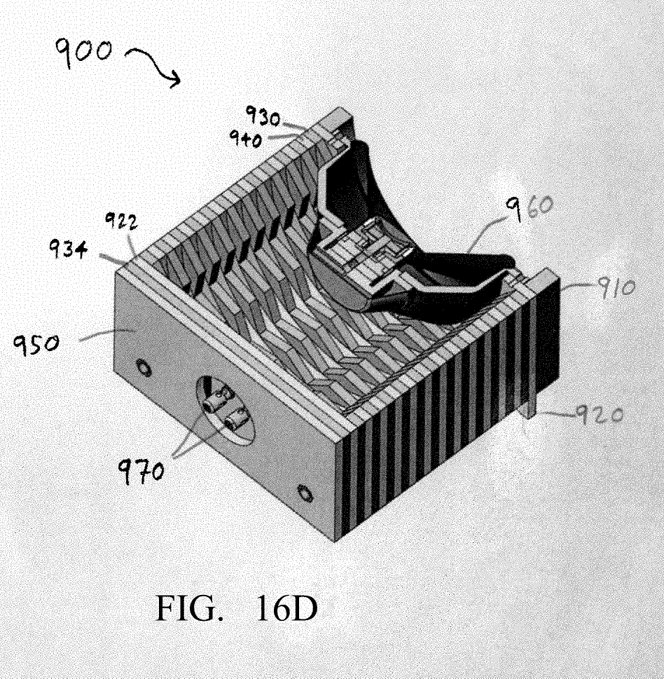

Embodiments according to the present disclosure can also comprise different types of speaker assemblies. FIGS. 16A-16D display speaker assembly 900 which comprises several different components, such as cabinet face 910, front stand 920, front porous layer 930, rigid layer 940, rear stand 922, rear porous layer 934, and cabinet back 950. Speaker assembly 900 can also comprise a number of different components, such as driver 960 and terminals 970. As shown in FIGS. 16A-16D, the design of speaker assembly 900 can be different from the designs of other speaker assembly embodiments herein.

As indicated above, the relative position of each component within speaker assembly 900 is also important. As such, FIG. 16D provides a sectional cut-out view of the relative component positions of speaker assembly 900. For instance, FIG. 16D identifies the location of each of the individual components with respect to the speaker assembly 900 as a whole.

It is understood that embodiments presented herein are meant to be exemplary. Embodiments of the present disclosure can comprise any combination of compatible features shown in the various figures, and these embodiments should not be limited to those expressly illustrated and discussed.

Although the present disclosure has been described in detail with reference to certain configurations thereof, other versions are possible. Therefore, the spirit and scope of the disclosure should not be limited to the versions described above.

The foregoing is intended to cover all modifications and alternative constructions falling within the spirit and scope of the disclosure as expressed in the appended claims, wherein no portion of the disclosure is intended, expressly or implicitly, to be dedicated to the public domain if not set forth in the claims.

We claim:

1. A speaker assembly, comprising:
a cabinet comprising a front opening, a plurality of first layers, and a plurality of second layers;
said plurality of first layers alternating with said plurality of second layers;
a speaker driver in a fixed position within said front opening; and
wherein at least some of said plurality of first layers comprise a porous material.

2. The speaker assembly of claim 1, wherein at least some of said plurality of second layers comprise a rigid material.

3. The speaker assembly of claim 2, wherein at least some of said plurality of second layers restrict the movement of at least some of said plurality of first layers.

4. The speaker assembly of claim 1, wherein at least some of said plurality of first layers are adjustable or replaceable.

5. The speaker assembly of claim 1, wherein said each of said plurality of first layers comprises a flow resistance.

6. The speaker assembly of claim 1, wherein air can pass through at least some of said plurality of first layers.

7. The speaker assembly of claim 1, wherein the air passing through said plurality of first layers causes aperiodic resonance damping.

8. The speaker assembly of claim 1, further comprising a grille over said front opening.

9. A speaker cabinet, comprising:
a front opening;
a plurality of first layers on said front opening; and
a plurality of second layers on said plurality of first layers;
said plurality of first layers alternating with said plurality of second layers;
wherein at least some of said plurality of first layers comprise a porous material.

10. The speaker cabinet of claim 9, wherein at least some of said plurality of second layers comprise a rigid material.

11. The speaker cabinet of claim 10, wherein at least some of said plurality of second layers restrict the movement of at least some of said plurality of first layers.

12. The speaker cabinet of claim 9, wherein air can pass through at least some of said plurality of first layers.

13. The speaker cabinet of claim 9, wherein at least some of said plurality of first layers are adjustable or replaceable.

14. The speaker cabinet of claim 9, wherein said each of said plurality of first layers comprises a flow resistance.

15. The speaker cabinet of claim 9, wherein at least one of said plurality of second layers comprises a stand.

16. A speaker assembly, comprising:
a cabinet comprising a front opening, a plurality of first layers, and a plurality of second layers;
said plurality of first layers alternating with said plurality of second layers;
a speaker driver in a fixed position within said front opening; and
a grille over said front opening.

17. The speaker assembly of claim 16, wherein at least some of said plurality of first layers comprise a porous material.

18. The speaker assembly of claim 16, wherein at least some of said plurality of second layers comprise a rigid material, such that said at least some of plurality of second layers restrict the movement of at least some of said plurality of first layers.

19. The speaker assembly of claim 17, wherein air can pass through at least some of said plurality of first layers.

20. The speaker assembly of claim 17, wherein at least some of said plurality of first layers are adjustable or replaceable.
